(19) United States
(12) Patent Application Publication
(10) Pub. No.: US 2023/0011425 A1
(43) Pub. Date: Jan. 12, 2023

(54) Method and System of Facilitating Crowdfunding for a Campaign

(71) Applicant: John R. Galley, Portland, ME (US)

(72) Inventor: John R. Galley, Portland, ME (US)

(21) Appl. No.: 17/810,920

(22) Filed: Jul. 6, 2022

Related U.S. Application Data
(60) Provisional application No. 63/218,697, filed on Jul. 6, 2021.

(51) Int. Cl. G06Q 30/02

(52) U.S. Cl. CPC G06Q 30/0279

(57) ABSTRACT

The method of the present invention functions to allow for a user to leverage their network of subject users to gain exponentially more donors for their campaign. To accomplish this, the method of the present invention includes a step of receiving a donation request from at least one individual hosting a campaign. The individual hosting the campaign sends a donation request which is a payment area linked to a webpage with information associated with the campaign of the inviter. Next the method has a step of transmitting the inviter donation request to at least one subject user who might contribute to the campaign. The next step in the method accomplishes the network leveraging by receiving a campaign request the newly invited user. Next the method has a step of analyzing the campaign request from the new user and generating a campaign associated with them. The next step in the method is transmitting the subject campaign request to at least one donor individual. Next the method has a step of receiving a donation from at least one of the donors.

### FIELD OF THE INVENTION

The present invention relates generally to data processing. More specifically, the present invention is a method and system for facilitating crowdfunding for a campaign and utilizing a network of individuals.

### BACKGROUND OF THE INVENTION

The field of data processing is technologically important to several industries, business organizations, and/or individuals. In particular, the use of data processing is prevalent for facilitating crowdfunding for a campaign.

The harsh truth is—as many as 90% of all Crowdfunding Campaigns fail to meet the goal creators hoped to achieve. After some initial, but limited success, most Campaigns “hit the wall”. Further, the crowdfunding campaigns then fade into obscurity and leave creators disappointed and disillusioned.

Existing techniques for facilitating crowdfunding for a campaign are deficient with regard to several aspects. For instance, current technologies do not generate the necessary traffic to the campaign and then convert that traffic into donations that produce more than just a handful of dollars. Therefore, there is a need for improved methods and systems for facilitating crowdfunding for a campaign that may overcome one or more of the above-mentioned problems and/or limitations.

### BRIEF DESCRIPTION OF THE DRAWINGS

FIG. 1 is an illustration of an online platform consistent with various embodiment of the present disclosure.

FIG. 2 is a block diagram of a computing device for implementing the methods disclosed herein, in accordance with some embodiments.

FIG. 3 is an illustration of a flowchart of the present invention.

FIG. 4 is an illustration of a flowchart of the present invention.

FIG. 5 is an illustration of a flowchart of the present invention.

FIG. 6 is an illustration of a flowchart of the present invention.

FIG. 7 is an illustration of a flowchart of the present invention.

FIG. 8 is an illustration of a flowchart of the present invention.

FIG. 9 is an illustration of a flowchart of the present invention.

FIG. 10 is a block diagram of the system of the present invention.

### DETAIL DESCRIPTIONS OF THE INVENTION

All illustrations of the drawings are for the purpose of describing selected versions of the present invention and are not intended to limit the scope of the present invention.

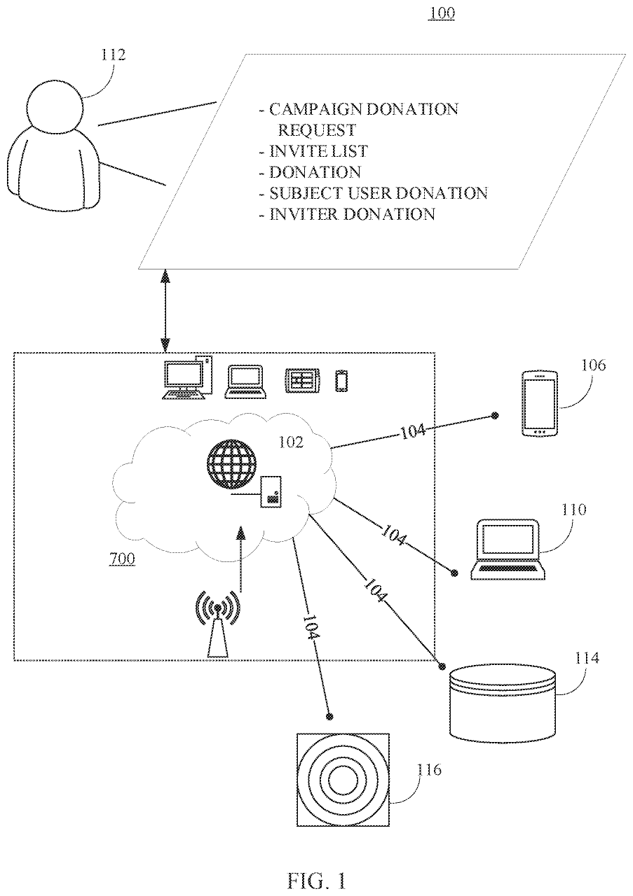

FIG. 1 is an illustration of an online platform 100 consistent with various embodiments of the present disclosure. By way of non-limiting example, the online platform 100 to enable facilitating management of employee data may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 200.

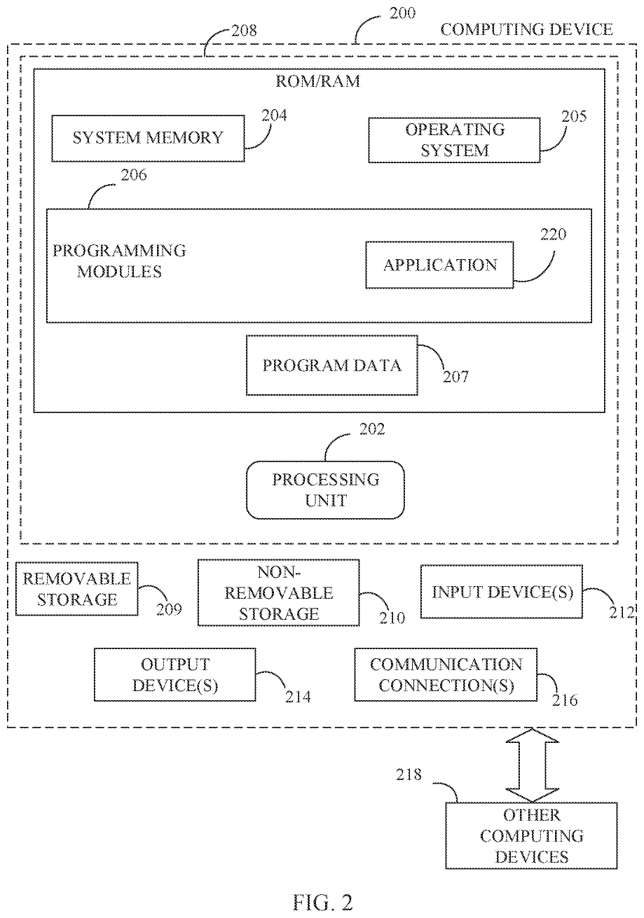

With reference to FIG. 2, a system 1000 consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device's 200 operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, several program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications

As can be seen in FIG. 1 through FIG. 10, the preferred embodiment of the present invention is a method for facilitating crowdfunding for a campaign. The method of the present invention allows a user to grow their network of supporters and people funding their campaign. This method allows individuals to easily expand their reach beyond their own contacts. An algorithm is designed to do the heavy lifting for the user by helping refer genuine supporters to their crowdfunding campaign to help reduce many financial challenges. The method of the present invention easily increases the number of donors a crowdfunding campaign receives without the need for increased networking from the user. For example, if an inviter gets three of their contacts to join their campaign, these three new users are then required to get additional donors to join who are then evenly split between the initial inviter and the new user, directly increasing the donations the inviter receives. In this way, the method of the present invention increases the leverage of the user when inviting their contacts to donate to their campaign.

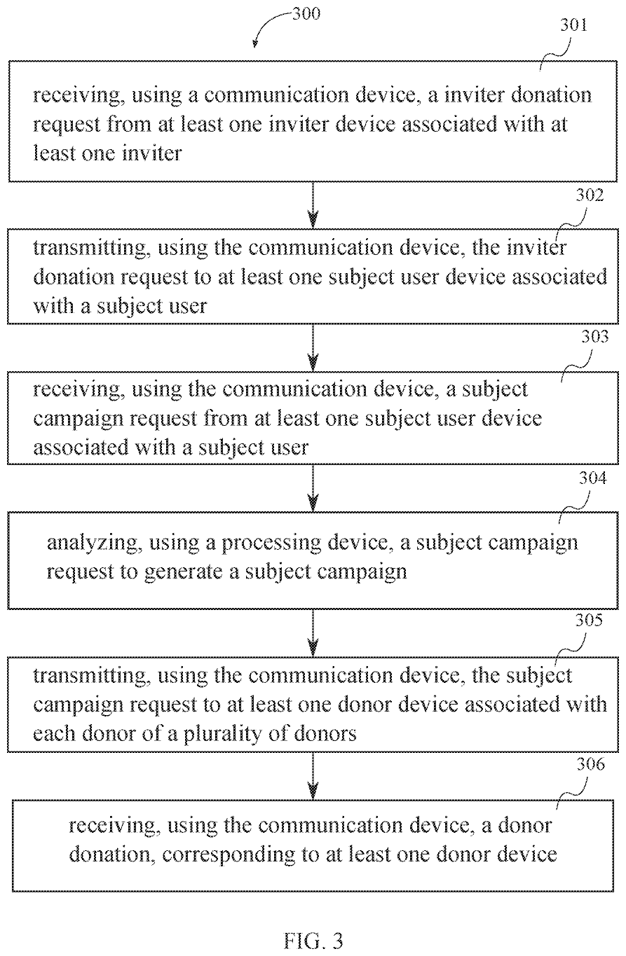

As can be seen in FIG. 3, the system 1000 used to execute the method 300 of the present invention allows the present invention to function as a way for an inviter to leverage their network of subject users to gain exponentially more donors for their campaign. To accomplish this, the method of the present invention may include a step 301 of receiving, using a communication device 1001, an inviter donation request from at least one inviter device associated with at least one inviter. The inviter donation request is a payment area linked to a webpage with information associated with the campaign of the inviter. The inviter device is an electronic device (such as the communication device 1001) that allows the inviter to create their donation request. The system 1000 used to execute the method of the present invention may include a step 302 of transmitting, using the communication device 1001, the inviter donation request to at least one subject user device associated with a subject user. The subject user device is an electronic device that is utilized by a subject user. Each subject user is an individual user who receives an inviter donation request from the inviter. For example, an inviter may send out multiple inviter donation requests and the subject users are the ones who receive their own inviter donation request.

As can be seen in FIG. 3, the system 1000 used to execute the method 300 of the present invention allows the present invention to function as a way for an inviter to leverage their network of subject users to gain exponentially more donors for their campaign. To accomplish this, the method of the present invention may include a step 303 of receiving, using the communication device 1001, a subject campaign request from at least one subject user device associated with a subject user. The subject campaign request is a web-page based form with information related to the campaign of the subject user such as name of the campaign, who the campaign is for, contact information for the subject user, etc. The system 1000 used to execute the method of the present invention may include a step 304 of analyzing, using a processing device 1002, a subject campaign request to generate a subject campaign. The processing device 1002 executes computer commands such as turning provided information into graphical user interfaces. The subject campaign is a web-page graphical user interface that is generated by the information provided from the subject campaign request. For example, if the subject user provides information into the subject campaign request a webpage is automatically generated for the subject user displaying their campaign information.

As can be seen in FIG. 3, the system 1000 used to execute the method 300 of the present invention allows the present invention to function as a way for an inviter to leverage their network of subject users to gain exponentially more donors for their campaign. To accomplish this, the method of the present invention may include a step 305 of transmitting, using the communication device 1001, the subject campaign request to at least one donor device associated with each donor of a plurality of donors. The donor device is an electronic device that is utilized by a donor to receive a subject campaign request. The system 1000 used to execute the method of the present invention may include a step 306 of receiving, using the communication device 1001, a donor donation, corresponding to at least one donor device. A donor donation is a monetary amount contributed by a donor from their associated donor device. For example, if a subject user sends out their subject campaign request to various donors and at least one donor wants to contribute to the subject campaign they can send their donor donation which is most cases is $50 or more.

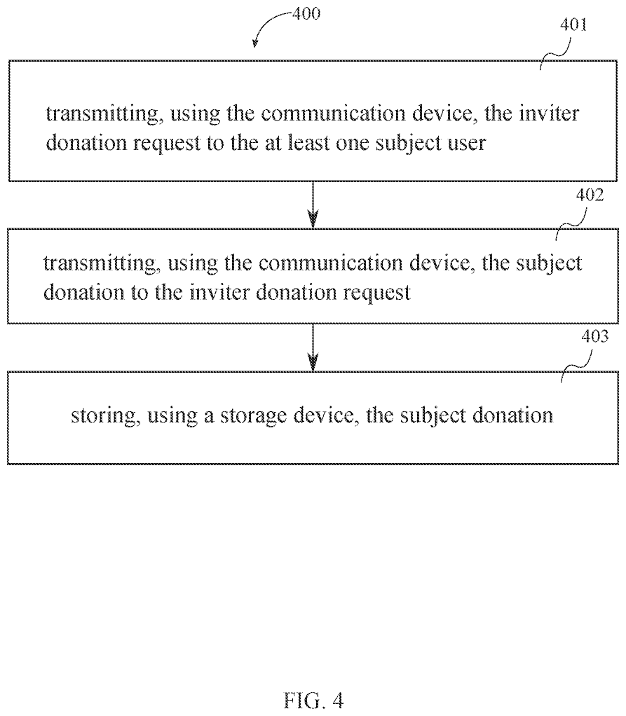

In reference to FIG. 4, a sub-process method 400 of the present invention enables the subject user to donate to the inviter's campaign. To that end, the sub-process begins with a step 401 by transmitting, using the communication device 1001, the inviter donation request to the at least one subject user. The inviter donation request is sent to multiple subject users allowing each subject user to contribute. The sub-process continues with a step 402 by transmitting, using the communication device 1001, the subject donation to the inviter donation request. The subject donation is a monetary amount associated with the subject user that is sent to the inviter donation request to support the inviter's campaign. The sub-process continues with a step 403 by storing, using a storage device 1003, the subject donation. The storage device 1003 is an electronic device designed for performing data storage or data retrieval operations. The subject donation is recorded and stored within the storage device 1003 for later access and use. For example, as a subject donation is received by the present invention, the monetary amount is stored within the storage device 1003 until the amount is transferred for use within the campaign.

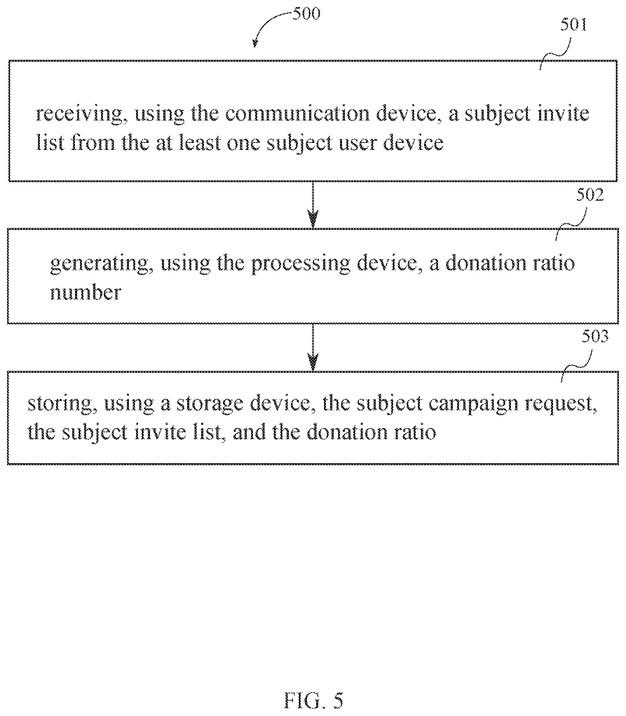

In reference to FIG. 5, a sub-process method 500 of the present invention enables subject users to increase the network reach of the inviter. To that end, the sub-process begins with a step 501 by receiving, using the communication device 1001, a subject invite list from the at least one subject user device. The subject invite list is a list of individual contacts with their information associated with the with subject user. Accordingly, the subject user device provides additional individual contacts through the communication device 1001. The sub-process continues with a step 502 by generating, using the processing device 1002, a donation ratio number. The donation ratio number is percentage such as 50% or ½. The donation ratio is predetermined and can be altered by the user. The sub-process continues with a step 503 by storing, using a storage device 1003, the subject campaign request, the subject invite list, and the donation ratio. The storage device 1003, the subject campaign request, the subject invite list and the donation ratio are all stored within the storage device 1003 to allow for later access. Continuing the previous example, once a subject is invited to the campaign, they then provide their contact list of individuals who would be interested in supporting a campaign.

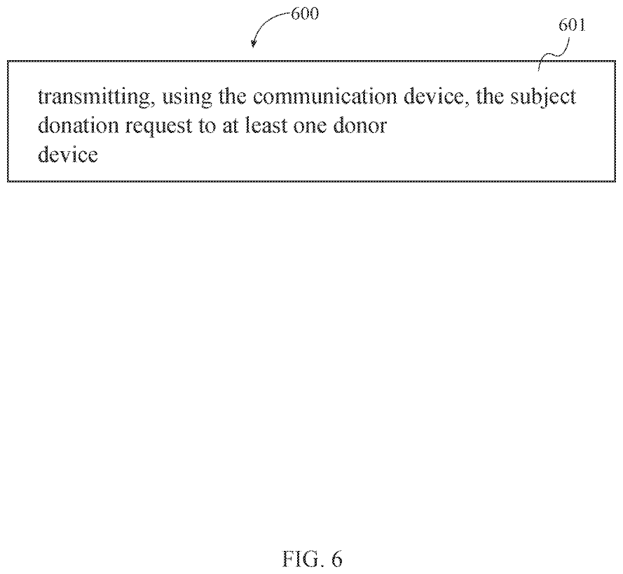

In reference to FIG. 6, a sub-process method 600 of the present invention enables a subject to request donations from donors. To that end, the sub-process begins with a step 601 by prompting transmitting, using the communication device 1001, the subject donation request to at least one donor device. The subject donation request is a payment area on a webpage associated with the information from the subject's campaign. The subject user may send the subject donation request to at least one donor, to potentially receive a donor donation. Returning again to the example, after a subject donates $50 to their inviter's campaign, they are then able to create their own campaign and send out donation requests to various people within their contact lists, referred to as donors.

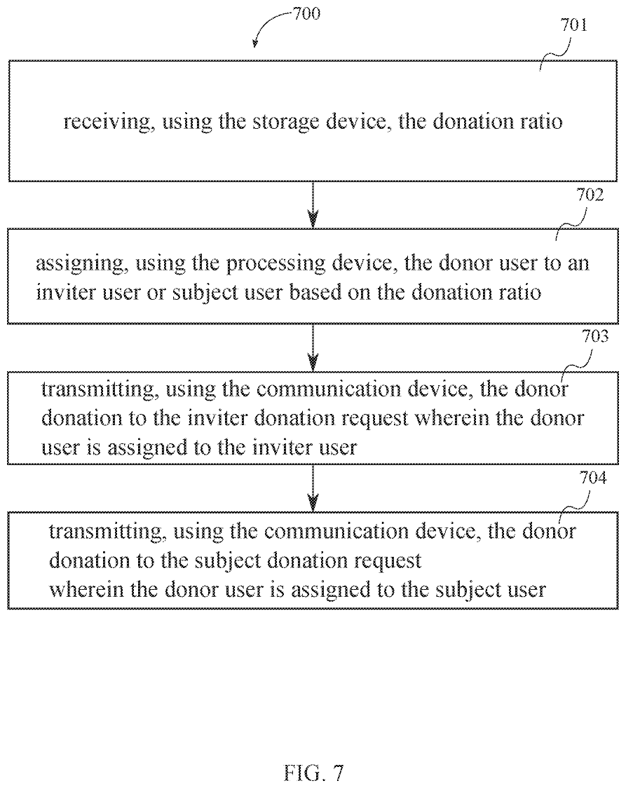

In reference to FIG. 7, a sub-process method 700 of the present invention enables donor donations to be divided based on the predetermined donation ratio. To that end, the sub-process with a step 701 begins by receiving, using the storage device 1003, the donation ratio. The donation ratio is accessed from the storage device 1003. The sub-process continues with a step 702 by assigning, using the processing device 1002, the donor user to an inviter user or subject user based on the donation ratio. For example, if the donation ratio is ½ then the first donor is assigned to the inviter user, the second donor is assigned to the subject user, the next donor is assigned to the inviter user, and so on. The sub-process continues with a step 703 by transmitting, using the communication device 1001, the donor donation to the inviter donation request wherein the donor user is assigned to the inviter user. The donor donation is only used for the inviter donation request when the specific donor user is assigned to the inviter user. The sub-process continues with a step 704 by transmitting, using the communication device 1001, the donor donation to the subject donation request wherein the donor user is assigned to the subject user. The donor donation is then only used for the subject donation request when the specific donor user is assigned to the subject user.

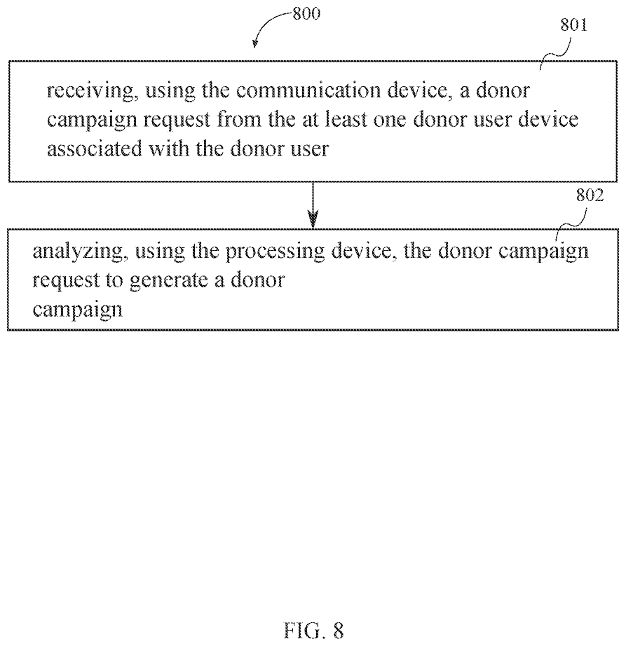

In reference to FIG. 8, a sub-process method 800 of the present invention enables the donor users to create their own campaign after contributing to a subject campaign or inviter campaign. To that end, the sub-process begins with a step 801 by receiving, using the communication device 1001, a donor campaign request from the at least one donor user device associated with the donor user. The donor campaign request is informational data relating to a donor campaign. The sub-process continues with a step 802 by analyzing, using the processing device 1002, the donor campaign request to generate a donor campaign. The donor campaign is a webpage that displays the information provided from the donor campaign request. Returning again to the previous example, once the donor has completed the $50 donation contribution to the subject or inviter's campaign, they can then fill out information about their own donor campaign that is then generated into a webpage displaying their donor campaign that can then be sent to additional users, continuing the aforementioned steps, increasing the reach of each user's network.

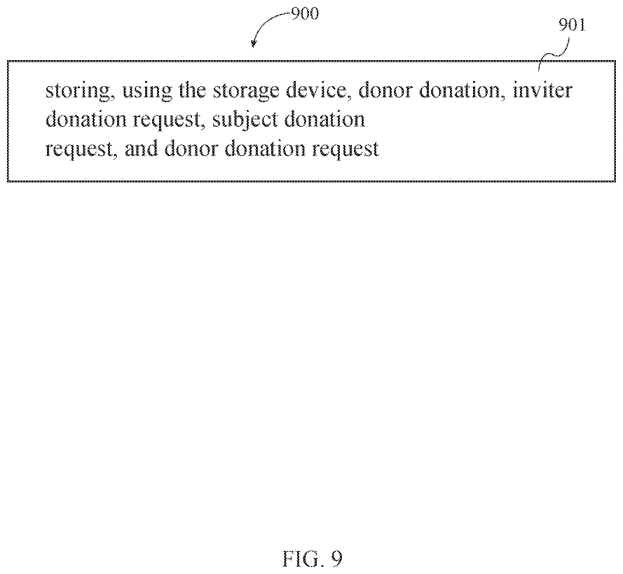

In reference to FIG. 9, a sub-process method 900 of the present invention enables users to store their information with the present invention to be used or accessed later. To that end, the sub-process begins with a step 901 by storing, using the storage device 1003, donor donation, inviter donation request, subject donation request, and donor donation request. The storage device 1003, donor donation, inviter donation request, subject donation request, and donor donation request can all be stored within the storage device 1003 to be utilized by the processing device 1002 or to be accessed at a later date by any of the users.

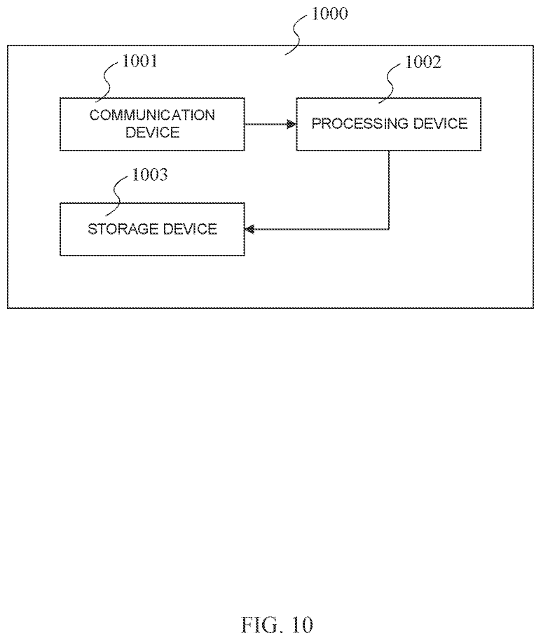

FIG. 10, illustrates a block diagram of a system 1000 for facilitating crowdfunding for a campaign, in accordance with some embodiments. Accordingly, the system 1000 may include a communication device 1001. Further the communication device 1001 may be configured for receiving an inviter donation request from at least one inviter device associated with at least one inviter. The inviter device being an electronic device utilized by an inviter. Further, the communication device 1001 may be configured for transmitting the inviter donation request to at least one subject user device associated with a subject user. Further, the communication device 1001 may be configured for receiving a subject campaign request from at least one subject user device associated with a subject user. Further, the communication device 1001 may be configured for transmitting the subject campaign request to at least one donor device associated with each donor of a plurality of donors. Further, the communication device 1001 may be configured for receiving a donor donation, corresponding to at least one donor device. Further, the system 1000 may include a processing device 1002 communicatively coupled with the communication device 1001. Further, the processing device 1002 may be configured for analyzing a subject campaign request to generate a subject campaign. Further, the processing device 1002 may be configured for generating a donation ratio number. Further, the processing device 1002 may be configured for assigning the donor user to an inviter user or subject user based on the donation ratio. Further, the system 1000 may include a storage device 1003 communicatively coupled with the processing device 1002. Further, the storage device 1003 may be configured for storing the subject donation. Further, the storage device 1003 may be configured for storing the donor donation, inviter donation request, subject donation request, and donor donation request.

Furthermore, in some embodiments the communication device 1001 may be configured for transmitting the inviter donation request to the at least one subject user. Further, the communication device 1001 may be configured for transmitting the subject donation to the inviter donation request. Further, the communication device 1001 may be configured for receiving a subject invite list from the at least one subject user device. Further, the storage device 1003 may be configured for storing the subject campaign request, the subject invite list, and the donation ratio. Further, the communication device 1001 may be configured for transmitting the subject donation request to at least one donor device. Further, the storage device 1003 may be configured for receiving the donation ratio. Further, the communication device 1001 may be configured for assigning the donor user to an inviter user or subject user based on the donation ratio. Further, the communication device 1001 may be configured for transmitting the donor donation to the inviter donation request wherein the donor user is assigned to the inviter user. Further, the communication device 1001 may be configured for transmitting the donor donation to the subject donation request wherein the donor user is assigned to the subject user.

Further, in some embodiments the communication device 1001 may be configured for receiving a donor campaign request from the at least one donor user device associated with the donor user. Further, the processing device 1002 may be configured for analyzing the donor campaign request to generate a donor campaign.

Although the invention has been explained in relation to its preferred embodiment, it is to be understood that many other possible modifications and variations can be made without departing from the spirit and scope of the invention as hereinafter claimed.

What is claimed is:

1. A method of facilitating crowdfunding for a campaign comprising the steps of:
receiving, using a communication device, an inviter donation request from at least one inviter device associated with at least one inviter;
transmitting, using the communication device, the inviter donation request to at least one subject user device associated with a subject user;
receiving, using the communication device, a subject campaign request from at least one subject user device associated with a subject user;
analyzing, using a processing device, a subject campaign request to generate a subject campaign;
transmitting, using the communication device, the subject campaign request to at least one donor device associated with each donor of a plurality of donors; and
receiving, using the communication device, a donor donation, corresponding to at least one donor device.

2. The method of facilitating crowdfunding for a campaign as claimed in claim 1 comprising:
transmitting, using the communication device, the inviter donation request to the at least one subject user;
transmitting, using the communication device, the subject donation to the inviter donation request; and
storing, using a storage device, the subject donation.

3. The method of facilitating crowdfunding for a campaign as claimed in claim 1 comprising:
receiving, using the communication device, a subject invite list from the at least one subject user device;
generating, using the processing device, a donation ratio number; and
storing, using a storage device, the subject campaign request, the subject invite list, and the donation ratio.

4. The method of facilitating crowdfunding for a campaign as claimed in claim 1 comprising transmitting, using the communication device, the subject donation request to at least one donor device.

5. The method of facilitating crowdfunding for a campaign as claimed in claim 3 comprising:
receiving, using the storage device, the donation ratio;
assigning, using the processing device, the donor user to an inviter user or subject user based on the donation ratio;
transmitting, using the communication device, the donor donation to the inviter donation request wherein the donor user is assigned to the inviter user; and
transmitting, using the communication device, the donor donation to the subject donation request wherein the donor user is assigned to the subject user.

6. The method of facilitating crowdfunding for a campaign as claimed in claim 2 comprising:
receiving, using the communication device, a donor campaign request from the at least one donor user device associated with the donor user; and
analyzing, using the processing device, the donor campaign request to generate a donor campaign.

7. The method of facilitating crowdfunding for a campaign as claimed in claim 5 comprising storing, using the storage device, donor donation, inviter donation request, subject donation request, and donor donation request.

8. A method of facilitating crowdfunding for a campaign comprising the steps of:
receiving, using a communication device, an inviter donation request from at least one inviter device associated with at least one inviter;
transmitting, using the communication device, the inviter donation request to at least one subject user device associated with a subject user;
receiving, using the communication device, a subject campaign request from at least one subject user device associated with a subject user;
analyzing, using a processing device, a subject campaign request to generate a subject campaign;
transmitting, using the communication device, the subject campaign request to at least one donor device associated with each donor of a plurality of donors;
receiving, using the communication device, a donor donation, corresponding to at least one donor device;
transmitting, using the communication device, the inviter donation request to the at least one subject user;
transmitting, using the communication device, the subject donation to the inviter donation request;
storing, using a storage device, the subject donation;
receiving, using the communication device, a subject invite list from the at least one subject user device generating, using the processing device, a donation ratio number;
storing, using a storage device, the subject campaign request, the subject invite list, and the donation ratio; and
transmitting, using the communication device, the subject donation request to at least one donor device.

9. The method of facilitating crowdfunding for a campaign as claimed in claim 8 comprising:
receiving, using the storage device, the donation ratio;
assigning, using the processing device, the donor user to an inviter user or subject user based on the donation ratio;
transmitting, using the communication device, the donor donation to the inviter donation request wherein the donor user is assigned to the inviter user; and
transmitting, using the communication device, the donor donation to the subject donation request wherein the donor user is assigned to the subject user.

10. The method of facilitating crowdfunding for a campaign as claimed in claim 8 comprising:
receiving, using the communication device, a donor campaign request from the at least one donor user device associated with the donor user; and
analyzing, using the processing device, the donor campaign request to generate a donor campaign.

11. The method of facilitating crowdfunding for a campaign as claimed in claim 9 comprising storing, using the storage device, donor donation, inviter donation request, subject donation request, and donor donation request.

12. A system for facilitating crowdfunding for a campaign, the system comprising:
a communication device configured for:
receiving an inviter donation request from at least one inviter device associated with at least one inviter;
transmitting the inviter donation request to at least one subject user device associated with a subject user;
receiving a subject campaign request from at least one subject user device associated with a subject user;
transmitting the subject campaign request to at least one donor device associated with each donor of a plurality of donors;
receiving a donor donation, corresponding to at least one donor device;
a processing device configured for:
analyzing a subject campaign request to generate a subject campaign;
generating a donation ratio number; and
assigning the donor user to an inviter user or subject user based on the donation ratio;
a storage device configured for:
storing the subject donation; and
storing the donor donation, inviter donation request, subject donation request, and donor donation request.

13. The system of facilitating crowdfunding for a campaign as claimed in claim 12 where in the communication device is further configured for:
transmitting the inviter donation request to the at least one subject user; and
transmitting the subject donation to the inviter donation request.

14. The system of facilitating crowdfunding for a campaign as claimed in claim 12 wherein the communication device is further configured for receiving a subject invite list from the at least one subject user device.

15. The system of facilitating crowdfunding for a campaign as claimed in claim 12 wherein the storage device is further configured for storing the subject campaign request, the subject invite list, and the donation ratio.

16. The system of facilitating crowdfunding for a campaign as claimed in claim 12 wherein the communication device is further configured for transmitting the subject donation request to at least one donor device.

17. The system of facilitating crowdfunding for a campaign as claimed in claim 12 wherein the storage device is further configured for receiving the donation ratio.

18. The system of facilitating crowdfunding for a campaign as claimed in claim 12 wherein the communication device is further configured for:
assigning the donor user to an inviter user or subject user based on the donation ratio;
transmitting the donor donation to the inviter donation request wherein the donor user is assigned to the inviter user; and
transmitting the donor donation to the subject donation request wherein the donor user is assigned to the subject user.

19. The system of facilitating crowdfunding for a campaign as claimed in claim 13 wherein the communication device is further configured for receiving a donor campaign request from the at least one donor user device associated with the donor user.

20. The system of facilitating crowdfunding for a campaign as claimed in claim 13 wherein the processing device is further configured for analyzing the donor campaign request to generate a donor campaign.
